(19) United States
(12) Patent Application Publication
(10) Pub. No.: US 2021/0365641 A1
(43) Pub. Date: Nov. 25, 2021

(54) SPEECH RECOGNITION AND TRANSLATION METHOD AND TRANSLATION APPARATUS

(71) Applicant: LANGOGO TECHNOLOGY CO., LTD, Shenzhen (CN)

(72) Inventors: Yan Zhang, Shenzhen (CN); Tao Xiong, Shenzhen (CN)

(21) Appl. No.: 16/470,978

(22) PCT Filed: Apr. 9, 2019
(86) PCT No.: PCT/CN2019/081886

§ 371 Date: Jun. 19, 2019

(30) Foreign Application Priority Data
Jun. 12, 2018 (CN) 201810602359.4
Jun. 12, 2018 (CN) 201820905381.1

(51) Int. Cl. G06F 40/51; G10L 15/00; G10L 15/26; G10L 15/08; G10L 13/08

(52) U.S. Cl. CPC G06F 40/51; G10L 15/005; G10L 13/08; G10L 15/083; G10L 15/26

(57) ABSTRACT

There are a speech recognition and translation method as well as a translation apparatus. The method includes: entering a speech recognition state in response to the translation button being pressed, and collecting a voice of a user through the sound collecting device; importing the collected voice into each of a plurality of speech recognition engines through the processor to obtain a confidence of the voices corresponding to a plurality of different candidate languages, and determining a source language used by the user based on the confidence and a preset determination rule; exiting the speech recognition state in response to the translation button being released in the speech recognition state, and converting the voice of the source language to a target voice of a preset language through the processor; and playing the target voice through the sound playback device.

### BACKGROUND

### 1. Technical Field

The present disclosure relates to data processing technology, and particularly to a speech recognition and translation method and a translation apparatus.

### 2. Description of Related Art

So far, there are getting more and more types of translators, and their functions are getting more and more varied. Among them, them are some for translating network terms, and there are also some for translating Martian languages. Nowadays, translators are also called translating machine or the like. The translator supports translation in 33 languages and dialects including English, Chinese, Spanish, German, Russian, French, and the like, and has the capability of mutual translation between all of these languages. The current translation equipment is equipped with a plurality of buttons. When translating, the user needs to press the different buttons to perform the operations such as setting the source language and the target language, recording, and translation, which is cumbersome in operation and easy to cause translation errors due to pressing wrong button.

### SUMMARY

The embodiments of the present disclosure provide a speech recognition and translation method and a translation apparatus, which can be used to reduce and simplify translation operations and improve the accuracy of translation.

The embodiments of the present disclosure provides a speech recognition and translation method for a translation apparatus, where the translation apparatus includes a processor, a sound collecting device electrically coupled to the processor, and a sound playback device electrically coupled to the processor, where the translation apparatus is further provided with a translation button; where the method includes:

entering a speech recognition state in response to the translation button being pressed, and collecting a voice of a user through the sound collecting device; importing the collected voice into each of a plurality of speech recognition engines through the processor to obtain a confidence of the voices corresponding to a plurality of different candidate languages, and determining a source language used by the user based on the confidence and a preset determination rule, where each of the plurality of speech recognition engines corresponds to each of the plurality of different candidate languages; exiting the speech recognition state in response to the translation button being released in the speech recognition state, and converting the voice of the source language to a target voice of a preset language through the processor; and playing the target voice through the sound playback device.

The embodiments of the present disclosure further provides a translation apparatus, which includes:

a recording module configured to enter a speech recognition state in response to a translation button being pressed, and collecting a voice of a user through a sound collecting device; a voice recognizing module configured to import the collected voice into each of a plurality of speech recognition engines to obtain a confidence of the voices corresponding to a plurality of different candidate languages, and determining a source language used by the user based on the confidence and a preset determination rule, where each of the plurality of speech recognition engines corresponds to each of the plurality of different candidate languages; a voice converting module configured to exit the speech recognition state in response to the translation button being released in the speech recognition state, and converting the voice of the source language to a target voice of a preset language; and a playback module configured to play the target voice through the sound playback device.

The embodiments of the present disclosure further provides a translation apparatus, where the apparatus includes: an equipment body; a recording hole, a display screen, and a button disposed on a body of the equipment body; a processor, a storage, a sound collecting device, a sound playback device, and a communication module disposed inside the equipment body;

the display screen, the button, the storage, the sound collecting device, the sound playback device, and the communication module are electrically coupled to the processor;

the storage stores a computer program executable on the processor, and the following steps are performed when the processor executes the computer program:

entering a speech recognition state in response to the translation button being pressed, and collecting a voice of a user through the sound collecting device; importing the collected voice into each of a plurality of speech recognition engines to obtain a confidence of the voices corresponding to a plurality of different candidate languages, and determining a source language used by the user based on the confidence and a preset determination rule, where each of the plurality of speech recognition engines corresponds to each of the plurality of different candidate languages; exiting the speech recognition state in response to the translation button being released in the speech recognition state, and converting the voice of the source language to a target voice of a preset language; and playing the target voice through the sound playback device.

In each of the above-mentioned embodiments, it enters the speech recognition state in response to the translation button being pressed, collects the voice of the user in real time, and imports the collected voices into the plurality of speech recognition engines in real time to obtain the confidence of the voices corresponding to the plurality of different candidate languages, and then determines the source language used by the user based on the obtained confidence. In the speech recognition state, in response to the translation button being released, it exits the speech recognition state, and converts the voice of the source language to the target voice of the preset language so as to play. It realizes one-click translation and automatic recognition of the source language, thereby simplifying button operations, and is capable of avoiding the translation error caused by pressing the wrong button so as to improve the accuracy of translation.

### BRIEF DESCRIPTION OF THE DRAWINGS

FIG. 1 is a flow chart of an embodiment of a speech recognition and translation method according to the present disclosure.

FIG. 2 is a flow chart of another embodiment of a speech recognition and translation method according to the present disclosure.

FIG. 3 is a schematic structural diagram of an embodiment of a translation apparatus according to the present disclosure.

FIG. 4 is a schematic structural diagram of another embodiment of a translation apparatus according to the present disclosure.

FIG. 5 is a schematic structural diagram of the hardware of an embodiment of a translation apparatus according to the present disclosure.

FIG. 6 is a schematic diagram of the external structure of the translation apparatus of the embodiment shown in FIG. 5.

FIG. 7 is a schematic structural diagram of the hardware of another embodiment of a translation apparatus according to the present disclosure.

### DETAILED DESCRIPTION

In order to make the object, the features and the advantages of the present disclosure more obvious and easy to understand, the technical solutions in the embodiments of the present disclosure will be clearly and completely described below in conjunction with the drawings in the embodiments of the present disclosure. Apparently, the following embodiments are only part of the embodiments of the present disclosure, not all of the embodiments of the present disclosure. All other embodiments obtained based on the embodiments of the present disclosure by those skilled in the art without creative efforts are within the scope of the present disclosure.

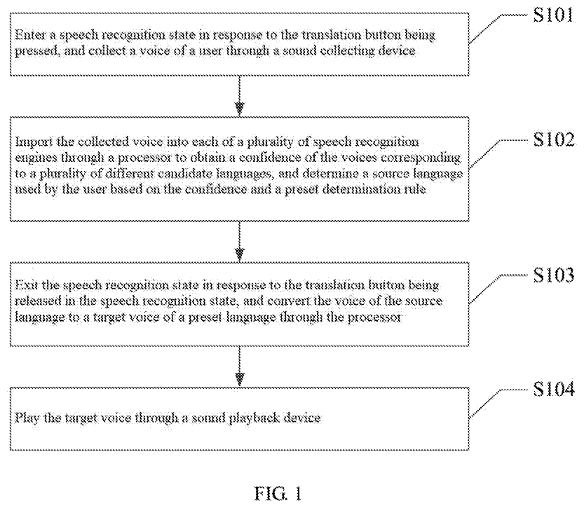

Please refer to FIG. 1, which is a flow chart of an embodiment of a speech recognition and translation method according to the present disclosure. The speech recognition and translation method is applied to a translation apparatus including a processor as well as a sound collecting device and a sound playback device which are electrically coupled to the processor. The translation apparatus is further provided with a translation button. In which, the sound collecting device can be, for example, a microphone or a pickup, and the sound playback device can be, for example, a speaker. The translation button can be a physical button or a virtual button. When the translation button is a virtual button, optionally, the translation apparatus further includes a touch screen. After powered on, the translation apparatus generates an interaction interface including only the virtual button and a demonstration animation of the virtual button, and then displays the interaction interface on the touch screen and plays the demonstration animation in the interaction interface. The demonstration animation is for illustrating the purpose of this virtual button. As shown in FIG. 1, the speech recognition and translation method includes:

S101: entering a speech recognition state in response to the translation button being pressed, and collecting a voice of a user through the sound collecting device.

S102: importing the collected voice into each of a plurality of speech recognition engines through the processor to obtain a confidence of the voices corresponding to a plurality of different candidate languages, and determining a source language used by the user based on the confidence and a preset determination rule.

S103: exiting the speech recognition state in response to the translation button being released in the speech recognition state, and converting the voice of the source language to a target voice of a preset language through the processor.

S104: playing the target voice through the sound playback device.

Specifically, the translation apparatus is provided with a plurality of speech recognition engines in advance, where each of the plurality of speech recognition engines corresponds to each of the plurality of different candidate languages. Whenever the translation button is pressed or released, different signals will be sent to the processor, and the processor will determine the state of the translation button based on the signal sent in response to pressing the translation button.

When the translation button is in a pressed state, the translation apparatus will enter the speech recognition state, collect the voice of the user in real time through the voice collection device, and synchronously import each of the collected voice into each of the plurality of speech recognition engines through the processor so as to perform voice recognition on the voices, and then obtain the confidence of the voices that correspond to different candidate languages. Then, according to the preset determination rule, the source language used by the user is determined by using the values of each obtained confidence. In which, the confidence can be considered as the probability of the accuracy of the text obtained from an audio waveform, that is, the probability that the language corresponding to the voice is the language corresponding to the speech recognition engine. For example, after the voice is imported into a Chinese speech recognition engine, the Chinese speech recognition engine will return the confidence of a Chinese recognition result, that is, the probability that the language corresponding to the voice is Chinese. Alternatively, the confidence can also be considered as a level of the confidence in the text recognized by an auto speech recognize (ASR) engine. For example, if an English voice is imported into a Chinese ASR engine, although the recognition result may include a Chinese text, the text is meaningless. The Chinese ASR engine has a low level of confidence in the recognition result, and correspondingly the output value of the confidence is also small.

In the speech recognition state, in response to the translation button being in a released state, the translation apparatus exits the speech recognition state and stops the voice collection, and converts all the voices of the source language which are collected in the speech recognition state to the target voice of the preset language, and the target voice is played through the sound playback device. In which, the preset language is set according to a setting operation of the user. The translation apparatus can set the language pointed to by a preset operation to the preset language according to the preset operation performed by the user. The preset operation may be, for example, a short pressing on the translation button; a click on various setting buttons on an interaction interface for language setting which is performed on a touch screen, a voice controlled setting operation, and the like.

Optionally, in another embodiment of the present disclosure, the translation apparatus further includes a wireless signal transceiving device electrically coupled to the processor; where the step of importing the collected voice into each of the plurality of speech recognition engines through the processor to obtain the confidence of the voices corresponding to the plurality of different candidate languages includes: importing the voice to a client corresponding to each of the plurality of speech recognition engines through the processor; transmitting the voice to a corresponding server in a form of streaming media in real time and receiving the confidence returned by each of the servers through the wireless signal transceiving device by each client; stopping the transmission of the voice in response to detecting a packet loss, a network speed which is less than a preset speed, or a disconnection rate which is greater than a preset frequency; and transmitting all the voices collected in the speech recognition state in a form of file to the corresponding server and receiving the confidence returned by each server through the wireless signal transceiving device by each client in response to detecting that the translation button is released in the speech recognition state, or recognizing the voice by calling a local database through the client to obtain the confidence.

In this embodiment, it enters the speech recognition state in response to the translation button being pressed, collects the voice of the user in real time, and imports the collected voices into the plurality of speech recognition engines in real time to obtain the confidence of the voices corresponding to the plurality of different candidate languages, and then determines the source language used by the user based on the obtained confidence. In the speech recognition state, in response to the translation button being released, it exits the speech recognition state, and converts the voice of the source language to the target voice of the preset language so as to play. It realizes one-click translation and automatic recognition of the source language, thereby simplifying button operations, and is capable of avoiding the translation error caused by pressing the wrong button so as to improve the accuracy of translation.

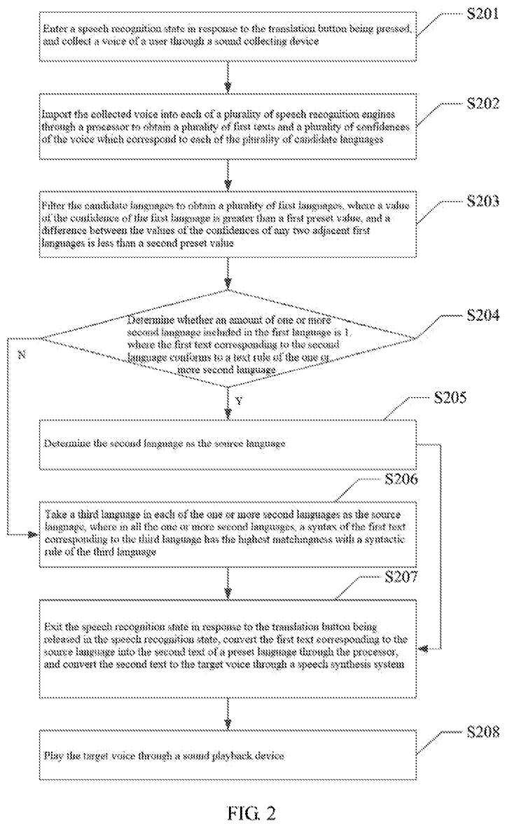

Please refer to FIG. 2, which is a flow chart of another embodiment of a speech recognition and translation method according to the present disclosure. The speech recognition and translation method is applied to a translation apparatus including a processor as well as a sound collecting device and a sound playback device which are electrically coupled to the processor. The translation apparatus is further provided with a translation button. In which, the sound collecting device can be, for example, a microphone or a pickup, and the sound playback device can be, for example, a speaker. The translation button can be a physical button or a virtual button. When the translation button is a virtual button, optionally, the translation apparatus further includes a touch screen. After powered on, the translation apparatus generates an interaction interface including only the virtual button and a demonstration animation of the virtual button, and then displays the interaction interface on the touch screen and plays the demonstration animation in the interaction interface. The demonstration animation is for illustrating the purpose of this virtual button. As shown in FIG. 2, the speech recognition and translation method includes:

S201: entering a speech recognition state in response to the translation button being pressed, and collecting a voice of a user through the sound collecting device.

S202: importing the collected voice into each of a plurality of speech recognition engines through the processor to obtain a plurality of first texts and a plurality of confidences of the voice which correspond to each of the plurality of candidate languages.

Specifically, the translation apparatus is provided with a plurality of speech recognition engines in advance, where each of the plurality of speech recognition engines corresponds to each of the plurality of different candidate languages. Whenever the translation button is pressed or released, different signals will be sent to the processor, and the processor will determine the state of the translation button based on the signal sent in response to pressing the translation button.

When the translation button is in a pressed state, the translation apparatus will enter the speech recognition state, collect the voice of the user in real time through the voice collection device, and synchronously import each of the collected voice into each of the plurality of speech recognition engines through the processor so as to perform voice recognition on the voices, and then obtain a recognition result of the voice corresponding to different candidate languages, where the recognition result includes the first text and the confidence which correspond to the voice. In which, the confidence can be considered as the probability of the accuracy of the text obtained from an audio waveform, that is, the probability that the language corresponding to the voice is the language corresponding to the speech recognition engine. For example, after the voice is imported into a Chinese speech recognition engine, the Chinese speech recognition engine will return the confidence of a Chinese recognition result, that is, the probability that the language corresponding to the voice is Chinese. Alternatively, the confidence can also be considered as a level of the confidence in the text recognized by an ASR engine. For example, if an English voice is imported into a Chinese ASR engine, although the recognition result may include a Chinese text, the text is meaningless. The Chinese ASR engine has a low level of confidence in the recognition result, and correspondingly the output value of the confidence is also small.

Optionally, in another embodiment of the present disclosure, the translation apparatus is further provided with a motion sensor electrically coupled to the processor. Then, in addition to use the translation button, the user can also control the translation apparatus to enter or exit the speech recognition state through preset actions. Specifically, a first action and a second action of the user which are detected through the motion sensor are set as a first preset action and a second preset action, respectively. If the user is detected to perform the first preset action, the speech recognition state is entered; and if the user is detected to perform the second preset action, the speech recognition state is exited. In which, the preset action may be, for example, an action of shaking the translation apparatus in a preset angle or frequency. The first preset action and the second preset action may be the same or different. The motion sensor can be, for example, an acceleration sensor, a gravity sensor, a gyroscope, or the like.

S203: filtering the candidate languages to obtain a plurality of first languages, where a value of the confidence of the first language is greater than a first preset value, and a difference between the values of the confidences of any two adjacent first languages is less than a second preset value.

S204: determining whether an amount of one or more second language included in the first language is 1, where the first text corresponding to the second language conforms to a text rule of the one or more second language.

S205: determining the second language as the source language, if the amount of the second language is 1.

S206: taking a third language in each of the one or more second languages as the source language, where in all the one or more second languages, a syntax of the first text corresponding to the third language has the highest matchingness with a syntactic rule of the third language.

In this embodiment, the preset determination rule is to determine the source language based on the value of the confidence, a result of a text rule matching, and a result of a syntax rule matching. By combining the confidence, the text rule matching, and the syntax rule matching, the accuracy to determine the source language can be improved.

For example, first, the first user sets the target language A that she or he wants; then, if the first user presses the button, the second user starts to speak using the language X (may be language a, b, c, d, e . . . or one of the other nearly one hundred types of languages in the world), and the apparatus starts to pick up the voices; and then, the apparatus imports the obtained voice of the second user into the speech recognition engine of each type of language, and determines that the language X used by the second user is which type of language based on the recognition result output by each speech recognition engine.

Assuming that the candidate languages are a, b, c, d, and e, the collected voices are respectively imported into the speech recognition engine Y1 of language a, the speech recognition engine Y2 of language b, the speech recognition engine Y3 of language c, the speech recognition engine Y4 of language d, and the speech recognition engine Y5 of the language e. The speech recognition engines Y1, Y2, Y3, Y4, and Y5 respectively recognize the voice and output the following recognition results:

the first text “a-Text 1” and the confidence “confidence 1” of the voice which correspond to language a; the first text “b-Text 1” and the confidence “confidence 2” of the voice which correspond to language b; the first text “c-Text 1” and the confidence “confidence 3” of the voice which correspond to language c; the first text “d-Text 1” and the confidence “confidence 4” of the voice which correspond to language d; the first text “e-Text 1” and the confidence “confidence 5” of the voice which correspond to language C.

Then, the language in the candidate language which has the value of the confidence lower than a preset value is excluded, and leaves a plurality of languages which have values of the confidences that are higher and similar to each other, for example, languages b, d and e which respectively correspond to “confidence 2”, “confidence 4”, and “confidence 5”.

Furthermore, it analyzes whether the remained first text “b-Text 1” consists with the text rule corresponding to language b, whether the remained first text “d-Text 1” consists with the text rule corresponding to language d, whether the remained first text “e-Text 1” consists with the text rule corresponding to language e. Taking the first text “b-Text 1” as an example, if language b is Japanese, it is analyzed whether there are non-Japanese characters in the first text “b-Text 1” and a specific weight of the non-Japanese characters in all the first text “b-Text 1” are less than a preset weight. If there is no non-Japanese text in the first text “b-Text 1”, or if the specific weight is less than the preset weight, it is determined that the first text “d-Text 1” conforms to the text rule corresponding to Japanese.

After the above-mentioned analysis, on the one hand, if only the first text “b-Text 1” conforms to the text rule corresponding to language b, it is determined that the language X used by the second user is language b. On the other hand, if the first text “b-Text 1” conforms to the text rule corresponding to language b, and the first text “e-Text 1” conforms to the text rule corresponding to language e, the first text “b-Text 1” is matched with the syntax rule corresponding to language b to obtain matchingness 1 of the first text “b-Text 1” and the syntax rule corresponding to language b, the first text “e-Text 1” is matched with the syntax rule corresponding to language e to obtain matchingness 2 of the first text “e-Text 1” and the syntax rule corresponding to language e, and the obtained matchingnesss 1 and 2 are compared. If the value of the matchingness 2 is the largest, it is determined that the language X used by the second user is language e. In which, the syntax includes grammar.

Optionally, in another embodiment of the present disclosure, the preset determining rule is to determine the source language according to the magnitude of the value of the confidence. Specifically, the language with the greatest value of the confidence in each candidate language is determined as the source language used by the user. For example, the above-mentioned “confidence 1”, “confidence 2”, “confidence 3”, “confidence 4”, and “confidence 5” are sorted in descending order. If “confidence 3” is the first in the order, language c corresponding to “confidence 3” is determined as the source language used by the second user. The method to determine the source language according to the value of the confidence is simple and has a small calculation amount, thereby improving the speed of determining the source language.

The speech recognition engine may perform voice recognition on the collected voice locally at the translation apparatus, or may send the voices to a server so as to perform voice recognition on the collected voice through the server.

Optionally, in another embodiment of the present disclosure, the voice is imported into the plurality of speech recognition engines through the processor, and a word probability list n-best of the voice to correspond to each candidate language is further obtained. After the source language is recognized, the first text corresponding to the source language is displayed on the touch screen. If it detects a click operation of the user on the touch screen, the first word in the first text displayed on the touch screen which is pointed by the click operation is switched to a second word, where the second word is a word in the word probability list n-best that has the probability second only to the first word. In which, the word probability list n-best includes a plurality of words that the recognized voice may correspond to, and the words are sorted according to a probability from large to small, for example, the voice pronounced as “shu xue” corresponds to multiple words including mathematics, blood transfusion, tree holes, and the like. By correcting the recognition result according to the click operation of the user, the accuracy of the translation can be further improved.

Optionally, in another embodiment of the present disclosure, the translation apparatus further includes a wireless signal transceiver device electrically coupled to the processor, and the step of importing the collected voice into each of the plurality of speech recognition engines through the processor to obtain the plurality of confidences and the plurality of first texts of the voices which correspond to different candidate languages may specifically include the following steps:

S2021: importing the voice to a client corresponding to each of the plurality of speech recognition engines through the processor.

In practical applications, the speech recognition engine and the client may have a one-to-one correspondence or a many-to-one correspondence.

Optionally, a plurality of speech recognition engines developed by a plurality of developers may be used according to the language type that the developer of each speech recognition engine is good at, for example, Baidu's Chinese speech recognition engine, Google's English speech recognition engine, and Microsoft's Japanese recognition engine, and the like. At this time, the client of each speech recognition engine respectively transmits the collected voice of the user to different servers so as to perform voice recognition. Because the developer of each speech recognition engine is good at different language type, the accuracy of the translation results can be further improved by integrating the speech recognition engines of different developers.

S2022: transmitting the voice to a corresponding server in a form of streaming media in real time and receiving the first texts and the confidence which are returned by each of the servers through the wireless signal transceiving device by each client.

S2023: stopping the transmission of the voice in response to detecting a packet loss, a network speed being less than a preset speed, or a disconnection rate being greater than a preset frequency.

S2024: transmitting all the voices collected in the speech recognition state in a form of file to the corresponding server and receiving the confidence and the first texts which are returned by each server through the wireless signal transceiving device by each client in response to detecting that the translation button is released in the speech recognition state.

In the scenario that the collected voice of user is converted to a file and sent to the server for voice recognition, if the corresponding first text is displayed on the display screen before the collected user voice is sent to the server in the form of file, the corresponding first text will no longer be displayed on the display when it stops to send the voice of the user in the form of streaming media.

Alternatively, when a packet loss, a network speed being less than a preset speed, or a disconnection rate being greater than a preset frequency is detected, it may stop sending the voice and recognize the voice by calling a local database through the client to obtain the corresponding confidence and first texts.

It can be understood that, when the network quality is not good, by using the local offline database to perform voice recognition, the translation delay caused by the problem of network quality can be avoided to improve the translation efficiency. To reduce space usage, the data amount of the local offline database is usually smaller than the data amount of a database in a server.

S207: exiting the speech recognition state in response to the translation button being released in the speech recognition state, converting the first text corresponding to the source language into the second text of a preset language through the processor, and converting the second text to the target voice through a speech synthesis system.

S208: playing the target voice through the sound playback device.

Specifically, in the speech recognition state, in response to the translation button being released, the translation apparatus exits the speech recognition state and stops the voice collection. Then, the first texts of the source language which correspond to all the voices collected in the speech recognition state are translated into the second texts of the preset language through the processor. And then, the second text is converted into the target voice by using a TTS (text to speech) speech synthesis system, and the target voice recognition state is played through a speaker.

In this embodiment, it enters the speech recognition state in response to the translation button being pressed, collects the voice of the user in real time, and imports the collected voices into the plurality of speech recognition engines in real time to obtain the confidence of the voices corresponding to the plurality of different candidate languages, and then determines the source language used by the user based on the obtained confidence. In the speech recognition state, in response to the translation button being released, it exits the speech recognition state, and converts the voice of the source language to the target voice of the preset language so as to play. It realizes one-click translation and automatic recognition of the source language, thereby simplifying button operations, and is capable of avoiding the translation error caused by pressing the wrong button so as to improve the accuracy of translation.

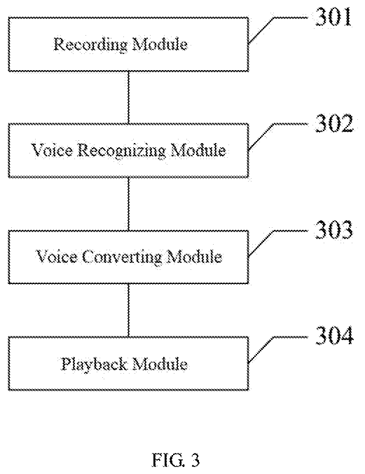

Please refer to FIG. 3, which is a schematic structural diagram of an embodiment of a translation apparatus according to the present disclosure. The translation apparatus can be used to implement the speech recognition and translation method shown in FIG. 1, and can be a translation apparatus as shown in FIG. 5 or 7, or a functional module in the translation apparatus. As shown in FIG. 3, the translation apparatus includes: a recording module 301, a voice recognizing module 302, a voice converting module 303, and a playback module 304.

The recording module 301 is configured to enter a speech recognition state in response to a translation button being pressed, and collecting a voice of a user through a sound collecting device.

The voice recognizing module 302 is configured to import the collected voice into each of a plurality of speech recognition engines to obtain a confidence of the voices corresponding to a plurality of different candidate languages, and determining a source language used by the user based on the confidence and a preset determination rule, where each of the plurality of speech recognition engines corresponds to each of the plurality of different candidate languages.

The voice converting module 303 is configured to exit the speech recognition state in response to the translation button being released in the speech recognition state, and converting the voice of the source language to a target voice of a preset language.

The playback module 304 is configured to play the target voice through the sound playback device.

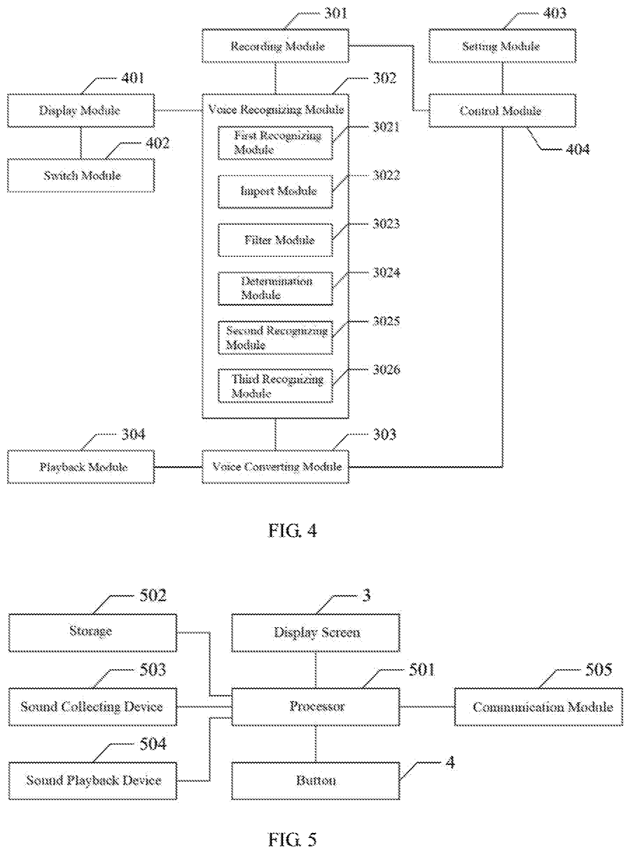

Furthermore, as shown in FIG. 4, in another embodiment of the present disclosure, the voice recognizing module 302 includes:

a first recognizing module 3021 configured to determine the language with the greatest value of the confidence in each candidate language as the source language used by the user.

Furthermore, the voice recognizing module 302 further includes:

an import module 3022 configured to import each of the voices into each of the plurality of speech recognition engines to obtain a plurality of first texts corresponding to each of the candidate languages and a plurality of the confidence;

a filter module 3023 configured to filter the candidate languages to obtain a plurality of first languages, where a value of the confidence of the first language is greater than a first preset value, and a difference between the values of the confidences of any two adjacent first languages is less than a second preset value;

a determination module 3024 configured to determine whether an amount of one or more second language included in the first language is 1, where the first text corresponding to the second language conforms to a text rule of the one or more second languages;

a second recognizing module 3025 configured to determine the second language as the source language, if the amount of the second language is 1;

a third recognizing module 3026 configured to take a third language in the one or more second languages as the source language, where in all the one or more second languages, a syntax of the first text corresponding to the third language has the highest matchingness with a syntactic rule of the third language.

Furthermore, the voice conversion module 303 is further configured to translate the first text corresponding to the source language into a second text of the preset language; and convert the second text to the target voice through a speech synthesis system.

Furthermore, the import module 3022 is further configured to import the voice to a client corresponding to each of the plurality of speech recognition engines through the processor;

transmit the voice to a corresponding server in a form of streaming media in real time and receiving the confidence returned by each of the servers through the wireless signal transceiving device by each client; and stop the transmission of the voice by each client in response to detecting a packet loss, a network speed being less than a preset speed, or a disconnection rate being greater than a preset frequency.

The import module 3022 is further configured to transmit all the voices collected in the speech recognition state in a form of file to the corresponding server and receiving the confidence returned by each server through the wireless signal transceiving device by each client in response to detecting the translation button being released in the speech recognition state.

The import module 3022 is further configured to recognize the voice by calling a local database through the client to obtain the confidence.

Furthermore, the import module 3022 is further configured to import each of the voices to the plurality of the speech recognition engines to obtain a word probability list corresponding to each of the candidate language.

The translation apparatus further includes:

A display module 401 configured to display the first text corresponding to the source language on the touch screen after the source language is recognized.

A switch module 402 configured to switch the first word in the first text displayed on the touch screen pointed by a click of the user to a second word, in response to detecting the click on the touch screen.

Furthermore, the translation apparatus further includes:

a setting module 403 configured to set a first action and a second action of the user detected through the motion sensor as a first preset action and a second preset action, respectively.

a control module 404 configured to control the translation apparatus to enter the speech recognition state in response to detecting the user having performed the first preset action through the motion sensor.

The control module 404 is further configured to exit the speech recognition state in response to detecting the user having performed the second preset action through the motion sensor.

For the specific processes of implementing the respective functions of the above-mentioned modules, reference may be made to related contents in the embodiments shown in FIG. 1-FIG. 2, which are not described herein.

In this embodiment, it enters the speech recognition state in response to the translation button being pressed, collects the voice of the user in real time, and imports the collected voices into the plurality of speech recognition engines in real time to obtain the confidence of the voices corresponding to the plurality of different candidate languages, and then determines the source language used by the user based on the obtained confidence. In the speech recognition state, in response to the translation button being released, it exits the speech recognition state, and converts the voice of the source language to the target voice of the preset language so as to play. It realizes one-click translation and automatic recognition of the source language, thereby simplifying button operations, and is capable of avoiding the translation error caused by pressing the wrong button so as to improve the accuracy of translation.

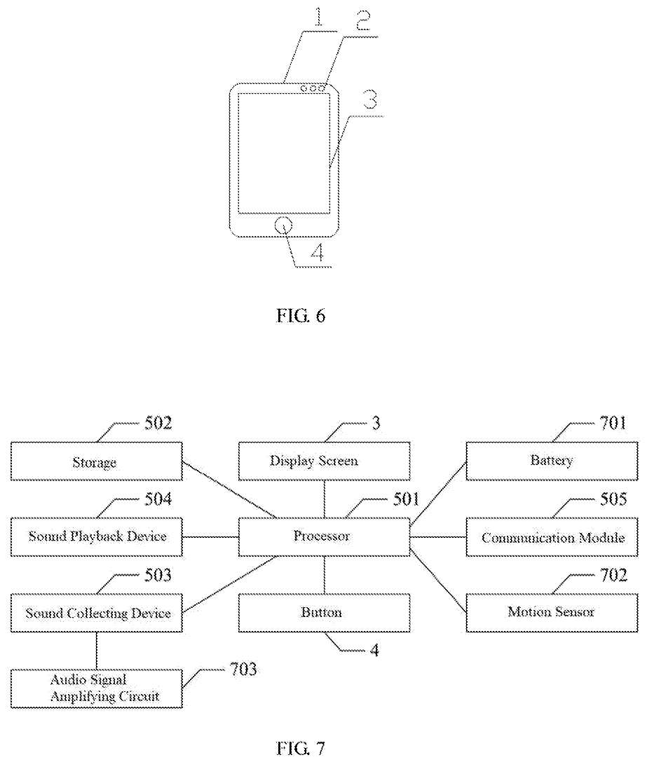

Please refer to FIG. 5 and FIG. 6. FIG. 5 is a schematic structural diagram of the hardware of an embodiment of a translation apparatus according to the present disclosure, and FIG. 6 is a schematic diagram of the external structure of the translation apparatus of the embodiment shown in FIG. 5.

As shown in FIG. 5 and FIG. 6, the translation apparatus described in this embodiment includes: an equipment body 1; a recording hole 2, a display screen 3, and a button 4 disposed on a body of the equipment body 1; and a processor 501, a storage 502, a sound collecting device 503, a sound playback device 504, and a communication module 505 disposed inside the equipment body 1.

The display screen 3, the button 4, the storage 502, the sound collecting device 503, the sound playback device 504, and the communication module 505 are electrically coupled to the processor 501. The storage 502 may be a high speed random access memory (RAM) or a non-volatile memory such as a magnetic disk. The storage 502 is for storing a set of executable program codes. The communication module 505 is a network signal transceiver for receiving and transmitting wireless network signals. The display screen 3 can be a touch display.

The storage 502 stores a computer program executable on the processor 501, and the following steps are performed when the processor 501 executes the computer program:

entering a speech recognition state in response to the button 4 being pressed, and collecting a voice of a user through the sound collecting device 503; importing the collected voice into each of a plurality of speech recognition engines to obtain a confidence of the voices corresponding to the plurality of different candidate languages, and determining a source language used by the user based on the confidence and a preset determination rule, where each of the plurality of speech recognition engines corresponds to each of the plurality of different candidate languages; exiting the speech recognition state if the button 4 is released in the speech recognition state, and converting the voice of the source language to a target voice of a preset language; and playing the target voice through the sound playback device 504.

Optionally, as shown in FIG. 7, in another embodiment of the present disclosure, a bottom of the equipment body 1 is provided with a speaker window (not shown in FIG. 7). Inside the equipment body 1 is further provided with a battery 701 and a motion sensor 702 both electrically coupled to the processor 501, and an audio signal amplifying circuit 703 electrically coupled to the sound collecting device 503. The motion sensor 702 may specifically be a gravity sensor, a gyroscope, an acceleration sensor, or the like.

For the specific processes of implementing the respective functions of the above-mentioned components, reference may be made to related contents in the embodiments shown in FIG. 1-FIG. 2, which are not described herein.

In this embodiment, it enters the speech recognition state in response to the translation button being pressed, collects the voice of the user in real time, and imports the collected voices into the plurality of speech recognition engines in real time to obtain the confidence of the voices corresponding to the plurality of different candidate languages, and then determines the source language used by the user based on the obtained confidence. In the speech recognition state, in response to the translation button being released, it exits the speech recognition state, and converts the voice of the source language to the target voice of the preset language so as to play. It realizes one-click translation and automatic recognition of the source language, thereby simplifying button operations, and is capable of avoiding the translation error caused by pressing the wrong button so as to improve the accuracy of translation.

In the embodiments provided by the present disclosure, it is to be understood that the disclosed apparatuses and methods can be implemented in other ways. For example, the device embodiments described above are merely illustrative; the division of the modules is merely a division of logical functions, and can be divided in other ways such as combining or integrating multiple modules or components with another system when being implemented; and some features can be ignored or not executed. In another aspect, the coupling such as direct coupling and communication connection which is shown or discussed can be implemented through some interfaces, and the indirect coupling and the communication connection between devices or modules can be electrical, mechanical, or otherwise.

The modules described as separated components can or cannot be physically separate, and the components shown as modules can or cannot be physical modules, that is, can be located in one place or distributed over a plurality of network elements. It is possible to select some or all of the modules in accordance with the actual needs to achieve the object of the embodiments.

In addition, each of the functional modules in each of the embodiments of the present disclosure can be integrated in one processing module. Each module can be physically exists alone, or two or more modules can be integrated in one module. The above-mentioned integrated module can be implemented either in the form of hardware, or in the form of software functional modules.

The integrated module can be stored in a computer-readable storage medium if it is implemented in the form of a software functional module and sold or utilized as a separate product. Based on this understanding, the technical solution of the present disclosure, either essentially or in part, contributes to the prior art, or all or a part of the technical solution can be embodied in the form of a software product. The software product is stored in a readable storage medium, which includes a number of instructions for enabling a computer device (which can be a personal computer, a server, a network device, etc.) to execute all or a part of the steps of the methods described in each of the embodiments of the present disclosure. The above-mentioned storage medium includes a variety of readable storage media such as a USB disk, a mobile hard disk, a read-only memory (ROM), a random access memory (RAM), a magnetic disk, and an optical disk which is capable of storing program codes.

It should be noted that, for the above-mentioned method embodiments, for the convenience of description, they are all described as a series of action combinations. However, those skilled in the art should understand that, the present disclosure is not limited by the described action sequence, because certain steps may be performed in other sequences or concurrently in accordance with the present disclosure. In addition, those skilled in the art should also understand that, the embodiments described in the specification are all preferred embodiments, and the actions and modules involved are not necessarily required by the present disclosure.

In the above-mentioned embodiments, the description of each embodiment has its focuses, and the parts which are not described in one embodiment may refer to the related descriptions in other embodiments.

The forgoing is a description of the speech recognition and translation method and the translation apparatus provided by the present disclosure. For those skilled in the art, according to the idea of the embodiment of the present disclosure, there will be changes in the specific implementation manner and the application range. In summary, the contents of the specification should not be comprehended as limitations to the present disclosure.

What is claimed is:

1. A speech recognition and translation method for a translation apparatus, wherein the translation apparatus comprises a processor, a sound collecting device electrically coupled to the processor, and a sound playback device electrically coupled to the processor; wherein the translation apparatus is further provided with a translation button; wherein the method comprises:
entering a speech recognition state in response to the translation button being pressed, and collecting a voice of a user through the sound collecting device;
importing the collected voice into each of a plurality of speech recognition engines through the processor to obtain a confidence of the voices corresponding to a plurality of different candidate languages, and determining a source language used by the user based on the confidence and a preset determination rule, wherein each of the plurality of speech recognition engines corresponds to each of the plurality of different candidate languages;
exiting the speech recognition state in response to the translation button being released in the speech recognition state, and converting the voice of the source language to a target voice of a preset language through the processor; and
playing the target voice through the sound playback device.

2. The method of claim 1, wherein the step of determining the source language used by the user based on the confidence and the preset determination rule comprises:
determining a language in the candidate languages with the highest confidence as the source language used by the user.

3. The method of claim 1, wherein the step of importing the collected voice into each of the plurality of speech recognition engines through the processor to obtain the confidence of the voices corresponding to the plurality of different candidate languages, and determining the source language used by the user based on the confidence and the preset determination rule comprises:
importing each of the voices into each of the plurality of speech recognition engines through the processor to obtain a plurality of first texts corresponding to each of the candidate languages and a plurality of the confidence;
filtering the candidate languages to obtain a plurality of first languages, wherein a value of the confidence of the first language is greater than a first preset value, and a difference between the values of the confidences of any two adjacent first languages is less than a second preset value;
determining whether an amount of one or more second language included in the first language is 1, wherein the first text corresponding to the second language conforms to a text rule of the one or more second languages;
determining the second language as the source language, if the amount of the second language is 1;
taking a third language in each of the one or more second languages as the source language, wherein in all the one or more second languages, a syntax of the first text corresponding to the third language has the highest matchingness with a syntactic rule of the third language.

4. The method of claim 3, wherein the step of converting the voice of the source language to the target voice of the preset language comprises:
translating the first text corresponding to the source language into a second text of the preset language; and
converting the second text to the target voice through a speech synthesis system.

5. The method of claim 1, wherein the translation apparatus further comprises a wireless signal transceiving device electrically coupled to the processor, wherein the step of importing the collected voice into each of the plurality of speech recognition engines through the processor to obtain the confidence of the voices corresponding to the plurality of different candidate languages comprises:
importing the voice to a client corresponding to each of the plurality of speech recognition engines through the processor;
transmitting the voice to a corresponding server in a form of streaming media in real time and receiving the confidence returned by each of the servers through the wireless signal transceiving device by each client;
stopping the transmission of the voice in response to detecting a packet loss, a network speed being less than a preset speed, or a disconnection rate being greater than a preset frequency; and
transmitting all the voices collected in the speech recognition state in a form of file to the corresponding server and receiving the confidence returned by each server through the wireless signal transceiving device by each client in response to detecting the translation button being released in the speech recognition state, or recognizing the voice by calling a local database through the client to obtain the confidence.

6. The method of claim 3, wherein the translation apparatus further comprises a touch screen electrically coupled to the processor, wherein the method further comprises:
importing each of the voices to the plurality of the speech recognition engines through the processor to obtain a word probability list corresponding to each of the candidate languages;
displaying the first text corresponding to the source language on the touch screen after the source language is recognized; and
switching the first word in the first text displayed on the touch screen pointed by a click of the user to a second word, in response to detecting the click on the touch screen.

7. The method of claim 1, wherein the translation apparatus is provided with a motion sensor electrically coupled to the processor, wherein the method further comprises:
setting a first action and a second action of the user detected through the motion sensor as a first preset action and a second preset action, respectively;
entering the speech recognition state in response to detecting the user having performed the first preset action through the motion sensor, and
exiting the speech recognition state in response to detecting the user having performed the second preset action through the motion sensor.

8. A translation apparatus, wherein the apparatus comprises:
a recording module configured to enter a speech recognition state in response to a translation button being pressed, and collecting a voice of a user through a sound collecting device;
a voice recognizing module configured to import the collected voice into each of a plurality of speech recognition engines to obtain a confidence of the voices corresponding to a plurality of different candidate languages, and determining a source language used by the user based on the confidence and a preset determination rule, wherein each of the plurality of speech recognition engines corresponds to each of the plurality of different candidate languages;
a voice converting module configured to exit the speech recognition state in response to the translation button being released in the speech recognition state, and converting the voice of the source language to a target voice of a preset language; and
a playback module configured to play the target voice through the sound playback device.

9. A translation apparatus, wherein the apparatus comprises:
an equipment body;
a recording hole, a display screen, and a button disposed on a body of the equipment body;
a processor, a storage, a sound collecting device, a sound playback device, and a communication module disposed inside the equipment body;
the display screen, the button, the storage, the sound collecting device, the sound playback device, and the communication module are electrically coupled to the processor;
the storage stores a computer program executable on the processor, and the following steps are performed when the processor executes the computer program:
entering a speech recognition state in response to the translation button being pressed, and collecting a voice of a user through the sound collecting device;
importing the collected voice into each of a plurality of speech recognition engines to obtain a confidence of the voices corresponding to the plurality of different candidate languages, and determining a source language used by the user based on the confidence and a preset determination rule, wherein each of the plurality of speech recognition engines corresponds to each of the plurality of different candidate languages;
exiting the speech recognition state in response to the translation button being released in the speech recognition state, and converting the voice of the source language to a target voice of a preset language; and
playing the target voice through the sound playback device.

10. The apparatus of claim 9, wherein:
a bottom of the equipment body is provided with a speaker window;
inside the equipment body is provided with a battery and a motion sensor both electrically coupled to the processor, and an audio signal amplifying circuit electrically coupled to the sound collecting device; and
the display screen is a touch screen.
